(19) United States
(12) Patent Application Publication
(10) Pub. No.: US 2002/0065047 A1
(43) Pub. Date: May 30, 2002

(54) Synchronization, channel estimation and pilot tone tracking system

(76) Inventor: Paul H. Moose, Carmel Valley, CA (US)

Correspondence Address: Pennie & Edmonds, LLP, 3300 Hillview Avenue, Palo Alto, CA, 94304, US

(21) Appl. No.: 09/955,912

(22) Filed: Sep. 18, 2001

Related U.S. Application Data
(60) Provisional application No. 60/250,724, filed on Nov. 30, 2000.

(51) Int. Cl. H04B 1/10; H04B 15/00; H04L 7/00

(52) U.S. Cl. 455/63; 375/354

(57) ABSTRACT

The invention provides for a method and system for properly tracking, synchronizing and demodulating received packets at a receiver in order to decode data and other informational symbols transmitted by a transmitter. The invention further provides for a method and system for correcting for distortion, phase shift, and frequency offset at a receiver due to variations in the frequencies transmitted by a transmitter. The system and method disclosed herein and employed for acquisition and initial synchronization is effectively immune to channel impairments, such as multi-path.

### CROSS-REFERENCE TO RELATED APPLICATIONS

This application claims priority to the provisional patent application Serial No.: 60/250,724, filed on Nov. 30, 2000.

### FIELD OF THE INVENTION

The present invention relates to a method and apparatus concerning the synchronization of a receiver to a signal to accurately demodulate, decode and retrieve information transmitted across a communication channel.

### BACKGROUND OF THE INVENTION

Communication systems operate to transmit communication signals having informational content and other characteristics generated at, or applied or provided to, a transmitter upon the communication channel. A receiver receives the transmitted, communication signal and operates to recreate the informational content and other signal characteristics of the communication signal.

A radio communication system is a communication system in which the communication channel is formed of one or more bands of a frequency spectrum. In a radio communication system, the receiver is typically tuned to frequencies of the communication channel upon which the communication signal is transmitted and includes circuitry for demodulating, decoding and/or converting received signals into lower frequency or baseband signals which permit the informational content and other signal characteristics of the communication signal to be reconstructed. Radio-based communication systems enable communication to be effectuated between remotely-positioned transmitters and receivers without the need to form hard-wired or other fixed connection.

Distortion is sometimes introduced upon the transmitted signal. The distortion can, for instance, be caused by filter circuitry of the transmitter, or filter circuitry of the receiver, or the communication channel. Some transmission difficulties which distort the communication signal as the communication signal is transmitted by a transmitter to a receiver can sometimes be more readily overcome when digital communication techniques are utilized. Utilization of digital communication techniques is advantageous as communications systems can be efficiently integrated in countries or regions that adopt the standards.

Advances in communication technologies have permitted communication systems to utilize digital communication techniques. In digital communication systems, a transmitter digitizes an information signal to form a digital signal. Once digitized, the digital signal can be modulated, and once modulated, transmitted upon a communication channel. While some existing communication systems have been converted to permit the utilization of digital communication techniques, other communication systems have been planned, or have been made possible, as a result of technological advancements or the development of national or international standards.

In November 1999, the IEEE 802.11 standardization committee selected coherent orthogonal frequency division multiplexing (OFDM) as the basis for a 5 GHz wireless local area network (WLAN) standard [1]. This digital communication standard divides the 5150 MHz to 5350 MHz frequency band into eight 20-MHz communication channels. Each of these 20-MHz channels is composed of 52 narrow-band carriers. OFDM sends data in parallel across all of these carriers and aggregates the throughput. The standard supports data rates as high as 54 Mbps in 16.6 MFz occupied bandwidth on 20 MHz channelization.

The OFDM data symbols are 4 μsecs long and consist of 52 sub-carriers spaced at 312.5 KHz. As shown in FIG. 1, each symbol contains 48 information-bearing sub-carriers and 4 pilot sub-carriers. Assuming a 20 MHz sampling rate, the OFDM symbols can be generated by a length 64 inverse fast Fourier transform (IFFT). The inputs to the IFFT are 48 information bearing modulation values drawn from a BPSK, QPSK, 16-QAM or 64-QAM constellation according to the chosen data rate, 4 known BPSK modulation values prescribed for the pilot sub-carriers and 12 null values [1]. The 64 complex values output from the IFFT are baseband discrete time samples of the sub-carrier multiplex. A 16 sample point cyclic prefix is appended to these 64 sample points as a guard interval to complete the generation of an 80 sample point or 4-μsec duration OFDM data symbol as shown in FIG. 1.

A WLAN OFDM receiver must be properly synchronized with each received packet in order to decode the data being passed in the OFDM information symbols. The receiver must first detect the arrival of a packet. Further, the receiver must determine and correct for any carrier frequency offset imparted to the sub-carriers due to variation in the nominal values of the in-phase and quadrature (I/Q) modulator and up-converter oscillator frequencies in the transmitter and in the down-converter and I/Q de-modulator oscillator frequencies in the receiver. The receiver must determine the start time of the first OFDM data symbol in the packet. The receiver must determine and remove any amplitude and phase shift that may have been imparted to the sub-carriers during transmission through the multi-path channel. The 20 MHz sampling clock at the receiver must be synchronized with the 20 MHz sampling clock at the transmitter. The preamble and pilot sub-carriers described above and as specified in the IEEE 802.11a standard are provided for these purposes. However, the standard does not provide for methods of implementation of such characteristics. The invention described herein provides a highly practical, yet accurate and robust set of algorithms to synchronize and track packets conforming to the IEEE 802.11 standard and other standards.

It is in light of this background information related to digital communication systems that the significant improvements of the present invention have evolved.

### SUMMARY OF THE INVENTION

The invention provides for a method and system for properly tracking and synchronizing received packets at a receiver in order to decode data and other informational symbols transmitted by a transmitter. The invention further provides for a method and system for correcting for distortion, phase shift, and frequency offset at a receiver due to variations in the frequencies transmitted by a transmitter.

### BRIEF DESCRIPTION OF THE DRAWINGS

Additional objects and features of the invention will be more readily apparent from the following detailed description and appended claims when taken in conjunction with the drawings, in which:

FIG. 1 is a drawing illustrating a WLAN OFDM data symbol.

FIG. 2 is a drawing illustrating the packet preamble consisting of ten short OFDM sync symbols, and two long OFDM sync symbols with a double length guard interval.

FIG. 3 illustrates the QPSK and BPSK modulation values associated with the short and long sync symbol OFDM sub-carriers present in the preamble.

FIG. 4 is a diagram of the cross-correlator used in the initial iteration of the synchronization algorithm.

FIG. 5 shows the magnitude of the output of the correlator versus preamble sample point number.

FIG. 6 is a diagram of the fine frequency correction and sub-carrier demodulation for the second iteration of the synchronization algorithm

FIG. 7 shows the magnitude of the output of the correlator versus integer frequency shift for an integer frequency offset of p=−1.

FIG. 8 is diagram of the pilot tone tracking loop showing the error generation and corrections applied to the subsequent OFDM symbol.

### DETAILED DESCRIPTION OF THE INVENTION

Distortion on a transmission signal can be introduced by filter circuitry at a receiver, transmitter or across a communication channel there between. At the receiver, sub-carriers may have been shifted in frequency up or down by an arbitrary amount. Also, it is not known by the receiver at what sample instant the packet will arrive and most importantly the beginning sample instant of the first and subsequent OFDM data symbols is not known. In order to demodulate and decode the OFDM data symbols, the receiver must shift the sub-carriers to their correct frequencies and commence the demodulation and decoding process for each symbol at its first sample instant. The receiver is assumed to be a digital receiver such that the 20 MHz sample values of the in-phase and quadrature components of the received signal are available for processing by the digital synchronization circuitry.

Packet detection, symbol timing and carrier frequency offset correction preferably rely on a structured training sequence of special OFDM symbols contained in a packet preamble. The same preamble information may be used to estimate the channel in support of coherent demodulation employed by the receiver. Slow channel variations and residual carrier frequency error may be tracked and removed using pilot sub-carriers with known modulation that are inserted at prescribed slots in each OFDM symbol.

While the present invention described herein is based on specific specifications, characteristics and techniques based on the 802.11 standard, such specifications, characteristics and techniques are used for purposes of illustrating and describing the present invention. While description and drawings herein represent a preferred embodiment of the present invention, it will be understood that various additions, modifications and substitutions may be made to the specifications, characteristics and techniques of the 802.11 standard without departing from the spirit and scope of the present invention as defined in the accompanying claims. In particular, it will be clear to those skilled in the art that the present invention may be embodied in other specific forms, preamble formats and structures, data formats and structures, arrangements, proportions, and with other elements, materials, and components, without departing from the spirit or essential characteristics thereof. The presently disclosed embodiments are therefore to be considered in all respects as illustrative and not restrictive, the scope of the invention being indicated by the appended claims, and not limited to the foregoing description. Furthermore, it should be noted that the order in which the process is performed may vary without substantially altering the outcome of the process.

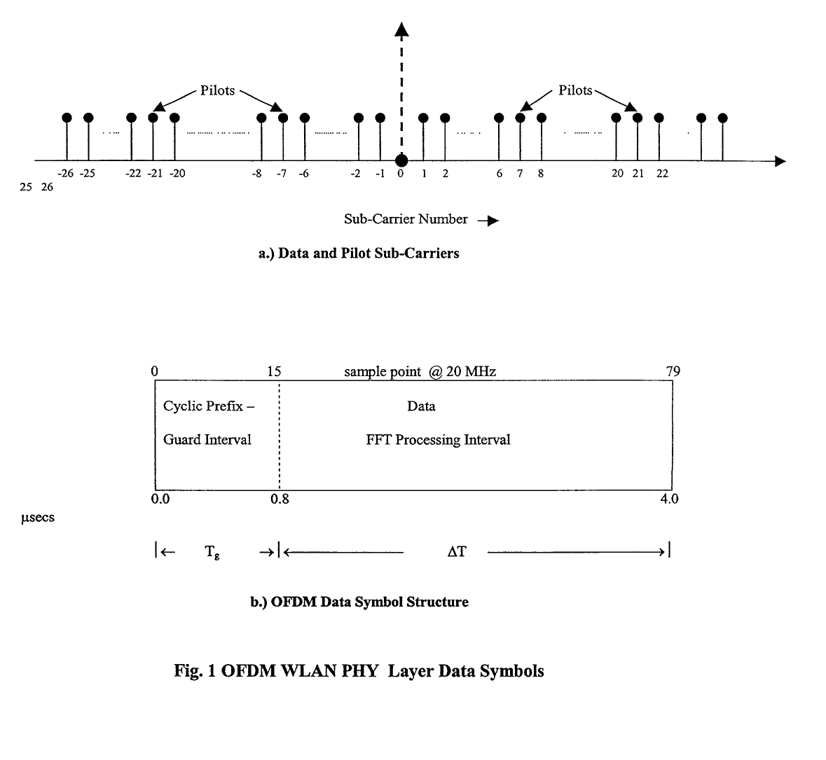

Returning now to FIG. 1, an OFDM data symbol consists of a cyclic prefix of 16 sample points and 64 sample points generated by a 64 point IFFT of the 53 sub-carrier modulation values plus 11 null values. As indicated in FIG. 1, the 53 sub-carrier modulation values consist of 48 data sub-carriers, four pilot sub-carriers and a null value for the center frequency or baseband D.C. term. The sub-carriers are spaced in frequency by an amount Δf=312.5 KHz. Each data sub-carrier is phase and/or amplitude modulated independently. The pilot sub-carriers are BPSK modulated with a known pseudo-random sequence that is removed at the receiver. The length of each data symbol is Tₛ=ΔT+T_{g} where ΔT=1/Δf=3.2 μsecs or 64 sample points at 20 MHz sampling rate and is called the OFDM FFT processing interval. T_{g}=0.8 μsecs or 16 sample points is a short guard interval filled with a cyclic extension that is the last 16 sample points of the signal in the processing interval ΔT and is included to preserve the orthogonality of the sub-carriers over the FFT processing interval in unequalized channels such as the WLAN multi-path channels.

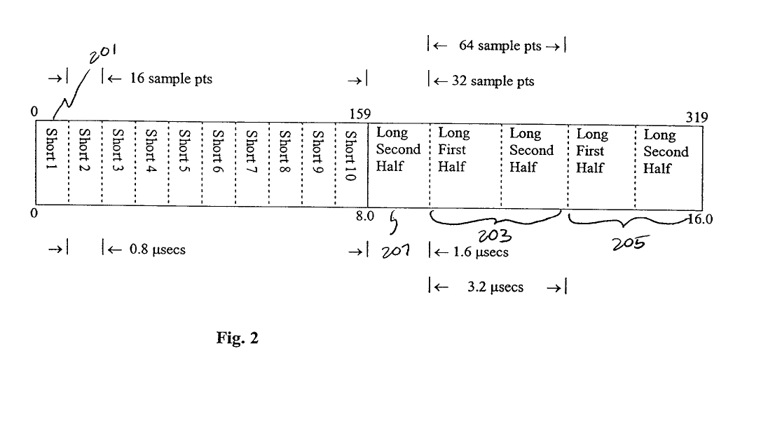

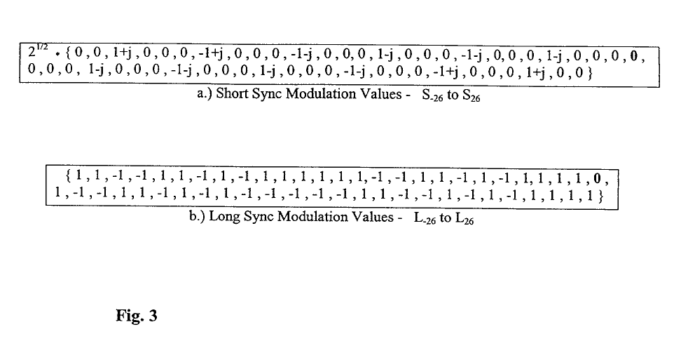

A training sequence, or preamble, having a duration of 16 μsecs or 320 sample points is illustrated in FIG. 2. FIG. 2 illustrates the packet preamble specified by the standard for synchronization and channel compensation. The sequence is shown consisting of a short OFDM sync symbol 201 of 0.8 μsecs or 16 sample points in duration, which is repeated 9 times, and a long OFDM sync symbol 203 of 3.2 μsecs or 64 sample points in duration, which is repeated once as sync symbol 205. A 1.6 μsec or 32-point duration guard interval 207 (which is just the second half of the points of the long sync symbol) is appended as a cyclic prefix to the long symbol pair. The short symbols may consist of 12 QPSK modulated sub-carriers as indicated in FIG. 3A, and the long symbols may consist of 52 BPSK modulated sub-carriers as indicated in FIG. 3B. Both long and short symbols may be generated using a 64-sample point IFFT with 12 prescribed modulation values and 52 nulls for the short symbols and 52 prescribed modulation values and 12 nulls for the long symbols. However, because the preamble is preferably identical for all packets, the discrete time sample values may be pre-computed and stored at the transmitter.

Initial Timing and Fine Fractional Frequency Offset Estimates

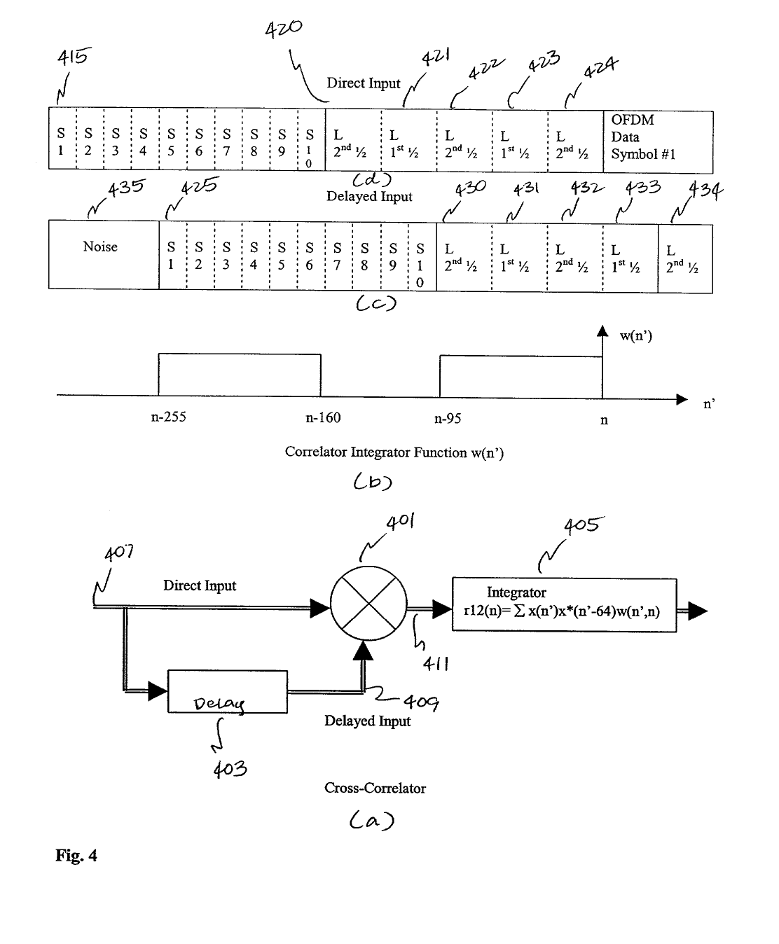

The digital synchronization circuitry of a preferred embodiment derives synchronization information from the preamble using an iterative process. Preferably, during a first iteration a digital cross-correlator 401, as shown in FIG. 4A, detects an incoming packet on input 407. The correlator is designed to utilize the maximum available coherent energy in the preamble for detection and to generate a sharp peak for an initial symbol-timing estimate. Carrier frequency offset is measured in terms of sub-carrier frequency spacing Δf (312.5 KHz). The frequency offset consists of an integer value and a fractional value. For example a value of −1.6 corresponds to a carrier frequency offset of −1.6*Δf (−1.6*312.5=−500 KHz).

In the preferred embodiment, the cross-correlator operates on the incoming sample stream with a 3.2 μsec or 64-sample point delay of one symbol via delay 403. The delayed input 409 is correlated with direct input 407 by correlator 401. The correlation output 411 is aggregated by integrator 405.

The correlation and integration function is described in more detail in FIGS. 4B-D. The direct input signal is represented in FIG. 4D comprising short sync symbols 415 followed by long sync symbols 420. The delayed input signal is represented in FIG. 4C where the short symbols 425 and long symbols 430 are shown preferably delayed 64 sample points. A preferred integration time is 9.6 μseconds or 192 sample points, preferably consisting of two 96-point intervals separated by 64 sample points and represented in FIG. 4B. When the last sample value of the long sync symbols at sample point 320, or the last point of the preamble sequence, enters the correlator's direct path, the correlation reaches a peak value.

The short sync symbols are periodic with a period of 16 and the first 96 overlapping symbols integrated by the correlator consist of the first 6 periods of the delayed input and the last six periods of the direct input. The long sync symbols are periodic with a period of 64. However, the two long sync symbols are preceded by the cyclic prefix 430 that consists of the last 32 samples of a long sync symbol. Thus at sample point 320 the last 96 overlapping points integrated in the correlator are 64 sample points of the first period of the long sync 431 in the delayed input and 64 sample points of the second period of the long sync 422 in the direct input plus the second half of the first long sync symbol 420 in the direct input and the cyclic prefix in the delayed input 430 which is identical to the second half of a long sync symbol.

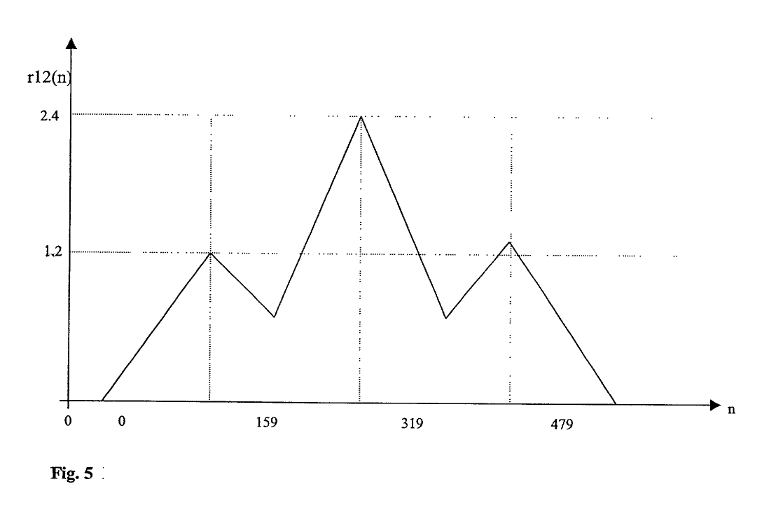

The expected value of the magnitude of the correlator output is shown in FIG. 5. The correlator has a processing gain of 192 (22.8 dB), the greatest that can be achieved under the WLAN standard. A peak detector can recognize the peak, and the peak's location provides an initial estimate of symbol timing. In a preferred embodiment, to prevent inter-symbol interference, the initial timing estimate is back biased, for example by 2 sample points (100 nsecs), to assure that the symbol sampling interval will commence at the end of the symbol guard interval and not after the beginning of the processing interval.

The aforementioned cross-correlator 401 preferably utilizes complex numbers to compute correlation. The complex numbers preferably have in-phase sample values as their real parts and quadrature sample values as their imaginary parts. The output of the correlator at each instant consists of a magnitude and a phase value. The aforementioned peak value is in fact a peak in the magnitude of the correlator output. The phase value of the correlator output at the instant of the peak measures the fractional amount of frequency offset of the sub-carriers.

Integer Frequency Offset Estimates and Channel Estimation

In a preferred embodiment, a second iteration is now performed, using the sample values from the long sync symbols with the timing of the first sample value determined by the initial timing estimate.

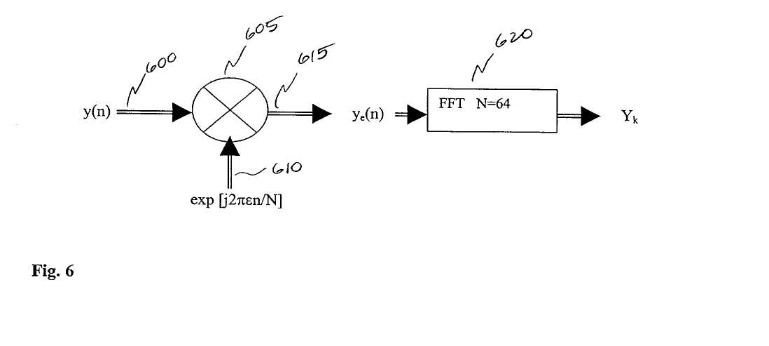

Reference is made to FIG. 6. The sample values 600 are frequency shifted by the fine fractional frequency estimate 610 obtained in the first iteration so that any residual frequency offset will be an integer multiple of the sub-carrier frequency spacing. The corrected symbol sample values 615 of the two long sync symbols are now demodulated using the receiver's demodulation circuitry preferably consisting of a fast Fourier transform (FFT) 620. The 64 sub-carrier modulation values of the first symbol are averaged with the 64 sub-carrier values of the second symbol for noise reduction. If there is no integer frequency offset, the 53 modulated sub-carriers (52 BPSK modulated carriers plus the DC null value sub-carrier) of this set will correspond to digital frequency numbers −26 thru +26. If there is an integer offset then they are shifted to digital frequency numbers −26 plus the offset thru +26 plus the offset. Sets of 53 sub-carrier modulation values with different offsets may be extracted from the 64 values to test for the integer offset. Each of these sets of 53 sub-carrier modulation values is divided by the known BPSK sub-carrier modulation values of the long sync symbol creating an estimate of the channel transfer function for each offset to be tested.

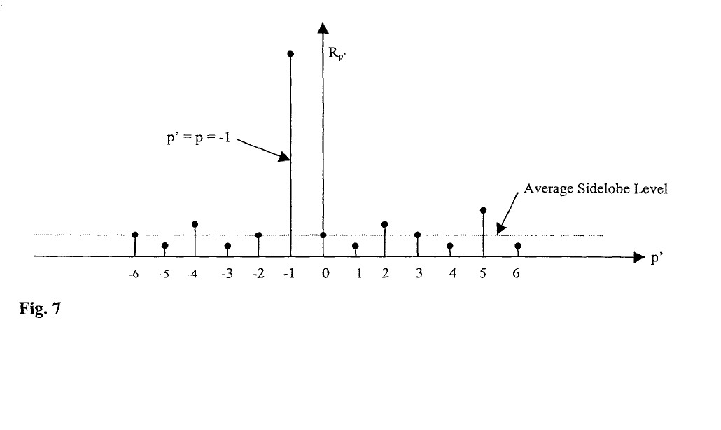

In a preferred embodiment, each of these estimates of the channel transfer function is processed in the following manner. First, the values corresponding to even sub-carrier numbers are used to create an interpolated estimate of the values corresponding to the odd sub-carrier numbers. These estimated odd numbered sub-carrier values may be correlated with the actual odd numbered sub-carrier values for each of the channel estimates. With reference to FIG. 7, for the channel estimate corresponding to the correct value of integer offset, very high correlation occurs due to the fact that the channel does not change randomly between adjacent carriers. As a result, it is possible to accurately predict the integer offset value given such values at nearby frequencies. For channel estimates corresponding to incorrect values of integer offset there is no correlation because in the division operation by the known BPSK values of the long sync, sub-carrier values are divided by modulation values corresponding to other sub-carriers. This quotient represents a random noise-like estimate for the channel where the odd numbered and even numbered values are completely uncorrelated. In these cases of random noise-like estimates, the correlation with the actual odd numbered values has an average value of zero. This approach not only reveals which integer carrier frequency offset is the correct one but also estimates the channel transfer function.

The range of the estimate for integer frequency offset is in principle unlimited. In practice, the range is limited by the IF bandwidth and/or the FFT size. In the preferred embodiment, the range for the integer value of frequency offset is ±6 or a maximum carrier frequency offset of ±1.875 MHz and is limited by the FFT size of 64. One of the advantages of the algorithm herein disclosed is that the algorithm offers the greatest range of all known carrier frequency offsets. Furthermore, the algorithm provides for maximum accuracy due to the high gain of the correlation operation. Standard carrier frequency offset algorithms use the short sync symbols to extend their range, but only to ±2 or a maximum allowed carrier frequency offset of ±625 KHz. Also, standard algorithms have less accuracy due to the lower gain in their correlators. The total frequency offset, consisting of fractional plus integer parts, is applied as a correction to the OFDM data symbols in the packet prior to demodulation and decoding.

The IEEE 802.11 standard specifies coherent demodulation for the OFDM subcarriers at the WLAN receivers. Any phase shift suffered by the sub-carriers in transmission must be corrected at the receiver. Also, because higher data rates use 16-QAM or 64-QAM modulation, amplitude variations introduced in transmission must also be corrected. The channel transfer function is required to provide for the combination of the multi-path propagation channel and all linear filter transfer functions in the WLAN transceiver and any residual symbol timing error. This required channel transfer function is in fact the channel transfer function corresponding to the correct integer frequency offset determined during the processing described above. This estimated transfer function is used to correct the sub-carrier amplitudes and phases following FFT demodulation and prior to decoding.

In an alternate preferred embodiment of the present invention, the channel transfer function estimate is continually updated during the packet reception using pilot tone information in order to correct for cumulating sampling clock error and any residual frequency offset error as described below.

Pilot Tone Tracking

In a preferred embodiment of the present invention, pilot tones are inserted in each OFDM data symbol at sub-carrier numbers ±7 (±2.1875 MHz) and ±21 (±6.5625 MHz) relative to the RF center frequency. These four sub-carriers are modulated with BPSK modulation values from a known PN sequence so that phase changes from data symbol to data symbol occurs in a prescribed manner known at the receiver. Phase changes from these known values are derived from the demodulation sequences extracted from the FFT outputs at the receiver. Phase changes may be used to track and correct for phase error buildup that may occur during the packet transmission and processing. Phase error may buildup during the packet due to at least three causes: (1) residual error in the carrier frequency offset estimate, (2) error between the sampling clock rates (20 MHz) of the transmitter and receiver and, (3) slow variations in the channel.

The maximum packet length that is permitted by the OFDM PHY layer WLAN standard is 1365 OFDM symbols (109200 sample points, or 5460 μsecs). In practice, although the first OFDM data symbol in the packet can be decoded with a residual carrier frequency offset error of ˜±10⁻² of the sub-carrier frequency spacing, the error must be less than ±10⁻⁵ of the sub-carrier frequency spacing in order to correctly decode the final OFDM symbol because of the phase error buildup induced by carrier frequency offset. Similarly, the sampling clock rates (20 MHz) must be equivalent within spacing tolerances less than ±0.4×10⁻⁶ MHz. Slow variations may occur in the channel although such variations are assumed to be very slow as compared to the length of the OFDM packets because the transmitters and receivers are generally and relatively fixed in their locations during operation (albeit, and not withstanding, the transmitters and receivers may be in the form of portable devices). Therefore, the main purpose of the pilot tone tracking is to eliminate phase error buildup due to very small frequency errors.

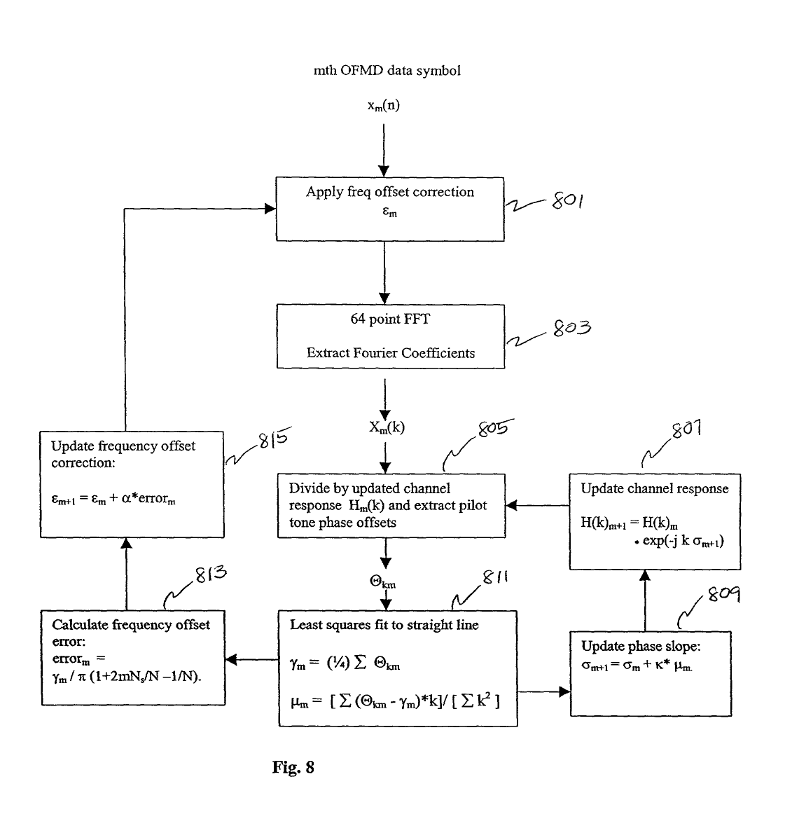

Pilot tones are generally used for synchronization and control purposes. The flow chart in FIG. 8 represents a tracking sequence based on pilot tones. The pilot tone tracking loop represents an estimation of phase change based on known transmitted pilot tone phases. Tracking the phase change based on OFDM symbols as described hereunder can be used to update symbol timing estimates for subsequent OFDM symbols. The pilot tone tracking is preferably represented by a first order digital tracking loop. The phase change of the pilot tones versus pilot tone sub-carrier frequency is obtained for each OFDM symbol from the FFT outputs at step 803 and the known transmitted pilot tone phases at step 805. In one approach, and as shown at step 811, a least squares fit is made to a straight line of phase change versus sub-carrier frequency using the demodulated phase change values of the four pilot sub-carriers. For such a case, the zero order term of this line will be the average phase change of the pilots and provides an updated estimate of any error in carrier frequency offset. A new estimate of frequency offset is obtained from the previous value at step 813 and the error and is applied to the subsequent OFDM symbol at step 815 prior to demodulation. The coefficient of the first order term of the line fit to the data is the average slope of the phase change versus sub-carrier frequency at step 809. This ratio determines any timing error that is accumulating due to mismatch in the sampling clock frequencies between the transmitter and receiver and is used to update the symbol-timing estimate for the subsequent OFDM symbol. In the preferred embodiment the update of the symbol-timing estimate is accomplished by updating the channel frequency response estimate at step 807. In an alternate embodiment, it is accomplished by slipping the OFDM symbol sampling clock initial starting sample.

The transmission system normally requires automatic gain control (AGC) to bring the signal level within dynamic range of the receiver. The rapidly changing gain of the AGC during the first several short sync symbols may cause the signal detection threshold to be exceeded prematurely. Blocking the signal inputs to the cross-correlator when the gain is changing too rapidly will prevent the signal detection threshold from being exceeded prematurely. A high rate of AGC gain change can be detected by monitoring the AGC error signal.

Mathematical details and representations of the foregoing are now provided. The short sync signal repeats itself every 16-sample points. A 64-point IFFT of a modulation sequence with non-zero values at every fourth sub-carrier will generate four periods of the short sync. Repeating this sequence 1.5 times generates the ten repetitions of the short sync of 160 sample points. The short sync may be described mathematically by its complex modulation envelope:

xs(n)=Σxsₖ(n),0≦n≦2.5*N−1,(N=64) (1)

where

xsₖ(n)=(2/N)exp[j(2πk(4)n/N+φₖ)],−6≦k≦6,k≠0 (2)

and φₖ are the QPSK phases defined in FIG. 3. Note from (1) and (2) that

xs(n)=xs(n−N/4),N/4≦n≦2.5N−1 (3)

so that xs(n) repeats ten times in 2.5N=160 sample points.

The long sync may be described mathematically by its complex modulation envelope

xl(n)=Σxlₖ(n),−N/2≦n≦2N−1,(N=64) (4)

where

xlₖ(n)=(1/N)exp[j(2πkn/N+φₖ)],−26≦k≦26,k≠0 (5)

and φₖ are the BPSK phases defined in FIG. 3. Note from (4) and (5) that

xl(n)=xl(n−N),N/2≦n≦2N−1,(N=64) (6)

so that xl(n) repeats 2 times in the 2N points from 0≦n≦2N−1. Furthermore, xl(n) from −N/2≦n≦−1 is identical to xl(n) from N/2≦n≦N−1 and to to xl(n) from 3N/2≦n≦2N−1 . That is, the first 32 points of xl(n) are a cyclic prefix of the basic N point IFFT xl(n).

The entire preamble may now defined by the 5N=320 sample point sequence

xsync=xs(n)+xl(n−3N),0≦n≦5N−1 (7)

The initial step of the detection and frequency/timing recovery process is to compute the correlation between the incoming signal samples and the same samples with a delay of N sample points. The integration window of the correlator consists of two intervals. The first integration interval is over the most recent 1.5N=96 points to enter the correlator. This interval is from point n to point n-95. The second portion of the integration interval also consists of 1.5N=96 points but includes those points beginning with the point entering the correlator 160 points earlier. This integration interval is from point n-160 to point n-255, as shown in FIG. 4. Consider this process applied to (7). The cross-correlation obtained at sample point 2.5N−1=159 reaches a local maximum given by

r12(2.5N−1)=72/N (8)

which is the energy in six periods of the short sync xs(n). This local maximum is succeeded by a global maximum at sample point 5N−1=319 given by

r12(5N−1)=72/N+78/N=150/N (9)

which is the energy in six periods of the short sync xs(n) plus the energy in 1.5 periods of the long sync xl(n).

At sample point 7.5N−1=479, the correlator output of a preferred embodiment of the invention reaches another local maximum given by

r12(7.5N−1)=78/N (10)

which is the energy in 1.5 periods of the long sync. In between the maxima, the correlator output follows a triangular function with a base of 192 sample points (see FIG. 5). A threshold is set halfway between the local maxima and the global maximum with a value r12_{TH=}114/N. Exceeding this threshold provides detection of an incoming packet. The sample point number of the global maximum (sample point 319 in the absence of error) provides the initial estimate for symbol timing.

The present invention accommodates the situation where the received signal has been subjected to an unknown amount of frequency shift offset. For example, assume the sampled frequency shifted signal is

ysync(n)=xsync(n)exp[j2π(p+ε)n/N],0≦n≦5N−1 (11 )

where

δf=(p+ε)Δf (12)

is the frequency offset and Δf is the sub-carrier spacing (312.5 KHz). The integer p gives frequency offset to the nearest sub-carrier and

−½≦ε≦½ (13)

is the fractional frequency offset. Returning now to the cross-correlator output, at sample point 5N−1 after the signal enters the receiver, the output is given by

r12(5N−1)=(150/N)exp[j2πε]. (14)

The magnitude of the output, as in (9), is the peak magnitude of the correlation and provides both detection and an initial estimate of the sample timing whereas the phase of the correlation according to its principal value between −π and π determines the fractional frequency offset ε between −½ and ½.

Assume the OFDM packet has been sent through a linear multi-path channel that introduces signal distortion in addition to introducing a frequency offset. This situation will be the case, for example, in WLAN in-door channels. For channels with an impulse response of length Nₕ sample points, the peak of the expected value of the correlation function output, which is still given by (14), may be shifted to lie between sample point 5N−1 and 5N+Nₕ−1. In practice it has been demonstrated that for the exponential decaying in-door WLAN channels the actual peak lies no greater than two sample points (100 nsecs) past 5N−1.

Due to the wide base of the triangular correlation function and the finite length of the channel impulse response, the sample timing offset is subject to an error of one or two samples. This error is normally biased to be greater than the true value due to the channel impulse response as mentioned above. In order to compensate for this delay in the peak, the initial timing estimate is back biased to a smaller value so that the symbol timing estimate for initiating the extraction of the first symbols will never exceed the correct value of, in this case, N=320. An error in the estimate that causes the symbol extraction to begin late, introduces inter-symbol interference (ISI). ISI occurs because the FFT processing interval will overlap the subsequent symbol. However, an error that causes the symbol extraction to begin early does not introduce (ISI) because of the guard interval. The associated timing shift if present is accommodated as part of the channel compensation. A bias of two sample points, say 100 nsecs, has been selected as optimum for the indoor WLAN channels.

The initial stage of the synchronization process described above has not resolved the integer frequency offset p. The second stage of the frequency/timing recovery process is used to determine p and to obtain an initial estimate of the channel transfer function. In a preferred embodiment and based on the initial timing estimate I, 2N long sync samples are extracted from the stored data stream. Preferably, there are 4N previous samples always stored in memory to support the correlation calculation associated with the initial stage of the processing, so there are no additional requirements for memory imposed by this process. Next, as shown in FIG. 6, these 2N samples are corrected by the estimated value of the fractional frequency offset ε using the algorithm:

ye(n)=y(n)exp[−j2πεn/N],I−2N≦n≦I−1, (15)

where I (nominally I=5N=320) is the sample number of the first sample in the symbol following the preamble as determined by the initial timing estimate. Now from (11)

ye(n)=xsync(n)exp[j2πpn/N],I−2N≦n≦I−1, (16)

so that the signal now consists of two periods of the long sync sequence offset by the integer frequency p:

yl(n)=xl(n)exp[j2πpn/N],I−5N≦n≦I−3N−1 (17)

Comparing (17) with (4) and (5) we see it is composed of the offset set of sub-carriers

yₖ(n)=(1/N)exp[j(2π(k+p)n/N+φₖ)],−26≦k≦26, k≠0. (18)

Next, and as shown in FIG. 6, the Fourier coefficients are preferably extracted using the N point FFT digital circuitry of the OFDM demodulator on the intervals I−5N≦n≦I−4N−1 and I−4N≦n≦I−3N−1 which, with the exception of timing error I−5N correspond to the two periods of the long sync. In the absence of noise, the N coefficients from both intervals are identical and are given by

Yₖ=exp(jφₖ₋ₚ)exp(j2πk(I−5N)/N),−26+p≦k≦26+p,k+p≠0.=0,−N/2≦k≦−26+p−1,26+p+1≦K≦N/2−1,k+p=0. (19)

In a preferred embodiment, the coefficients from the two intervals are averaged for noise reduction and (19) generates the expected values for the coefficients. Except for the linear phase shift introduced by any residual timing error I−5N, the Fourier coefficient sequence {Yₖ} of N (N=64) values is the long sync BPSK modulation sequence {exp(jφₖ)} of 52 values shifted by p in relation to its nominal centered location in the {Yₖ} sequence.

In practice, the multi-path channel may introduce additional phase shifts and amplitude variations onto the sub-carriers. Therefore the known BPSK modulation sequence {exp(jφₖ)} will have been modified by the unknown channel transfer function H(k). Therefore, (19) becomes

Yₖ=H(k−p)*exp(jφₖ₋ₚ),−26+p≦k≦26+p,k+p≠0.=0,−N/2≦k≦−26+p−1,26+p+1≦k≦N/2−1,k+p=0. (20)

where we have incorporated the phase shift due to timing error I−5N into the unknown channel response H(k). Next, the set of P=2pₘₐₓ+1 shifted test sequences of 52 received modulation values are formed as

Z_{k,p′}=Y_{k+p′}=H(k−(p−p′))*exp(jφ_{k-(p-p′)}),−pₘₐₓ ≦p′≦pₘₐₓ,−26≦k≦26,k≠0. (21)

A channel estimate for each p′ may be derived by multiplying the test sequences by the complex conjugate of the known modulation sequence

H_{p′}(k)=Z_{k,p′}exp(−jφₖ)=H(k−(p−p′))*exp(j(φ_{k-(p-p′)}−φₖ)), where −pₘₐₓ≦p′≦pₘₐₓ,−26≦k≦26,k≠0. (22)

Clearly when p′=p, H_{p′}(k)=H(k), the channel impulse response. When p′≠p, then

H_{p′}(k)=H(k−(p−p′))exp(j(φ_{k-(p-p′)}−φₖ))=H(k−(p−p′))exp(jλₖ) (23)

where λₖ=φ_{k-(p-p′)}−φₖ are uncorrelated and are equally likely to be 0 or π. Now insert a value for the DC term

H_{p′}(0)=[H_{p′}(−1)+H_{p′}(1)]/2

in order to obtain 53 sample point sequences for H_{p′}(k) for 26≦k≦26. The sequences of interpolated odd values of H_{p′}(k) is as follows:

H_{p′,odd/int}(k)=[H_{p′}(k−1)+H_{p′}(k+1)]/2, k=−25,−23, −21, . . . 23,25 (24)

where the actual observed odd value sequence is

H_{p′,odd}(k)=H_{p′}(k),k=−25,−23,−21, . . . 23,25 (25)

Each of the interpolated sequences are correlated with the actual odd value sequences for each value of p′ according to (See FIG. 7):

R_{p′}=ΣH_{p′,odd}(k)H*_{p′,odd/int}(k). (26)

First consider the case where p′=p, the correct offset. In this case H_{p′}(k)=H(k) and H_{odd}(k)≅H_{odd/int}(k), as the channel transfer function does not change randomly between adjacent sub-carriers. Accordingly, the channel response at an intermediate frequency can be accurately estimated from the response at adjacent nearby frequencies. In any event, a more accurate interpolation algorithm can be used than (24), if necessary. Therefore

Rₚ=ΣH_{odd}(k)H*_{odd/int}(k).≅ΣH_{odd}(k)H*_{odd}(k). =26|H|²_{avg} (27)

since there are 26 odd frequencies. Now consider the case where p′≠p. In this event H_{p′}(k)=H(k−(p−p′))exp(jλₖ). For simplicity, assume that channel transfer function H(k) is unity. Then H_{p′}(k)=Iₖ where Iₖ=exp(jλₖ) are uncorrelated zero mean random variables with values ±1 and variance one. Thus the interpolated odd values are

H_{p′,odd/int}(k)=[H_{p′}(k−1)+H_{p′}(k+1)]/2=[Iₖ₋₁+Iₖ₊₁]/2, where k=−25,−23,−21 . . . 23,25 (28)

and the actual odd values are

H_{p′,odd}(k)=Iₖ,k=−25,−23,−21 . . . 23,25 (29)

from which one finds that

E{R_{p′}}=ΣE{Iₖ(Iₖ₋₁+Iₖ₊₁)/2}=0 (30)

and

Var{R_{p′}}=26/2 (31)

In a non-unity gain channel, the variance is

Var{R_{p′}}≈(26/2)|H|⁴_{avg} (32)

so that the signal-sidelobe-ratio of the correlation to determine p is

SNR=Rₚ²/Var{R_{p′}}=52 (33)

Having determined the correct value for frequency offset p, the best estimate of the channel transfer function based on the two long sync symbols is simply that corresponding to p, that is

H(k)=Hₚ(k). (34)

There will be some residual carrier frequency offset due to error in the estimate obtained by processing the preamble as described above. Let m=0,1,2 . . . M−1 designate the OFDM data symbol number in an M symbol packet. Then

pₖₘ(n)=exp(j2πnk/N+φₖₘ)*exp(j2π(n+mNₛ+N_{g})εᵣₑₛ/N),n=0,1, . . . N−1 (35)

describes the pilot tone of frequency k (k=−21, −7, 7, 21) during OFDM data symbol number m during its processing interval of N points ( Nₛ=N+N_{g}=80 sample points). The BPSK pilot tone phases {φₖₘ} are known at the receiver. Now suppose we have an estimate εₘ of εᵣₑₛ at the beginning of this symbol so we correct the pilot tones and all the sub-carriers in the packet by the estimate such that

pcorrₖₘ(n)=exp[j(2πnk/N+φₖₘ)]*exp[j2π(n+mNₛ+N_{g})(εᵣₑₛ−εₘ)/N],n=0,1, . . . N−1. (36)

The FFT coefficients of the pilot tones for OFDM data symbol m are

Pₖₘ=exp[jφₖₘ)]*exp [jπ(1+2(mNₛ+N_{g})/N−1/N)(εᵣₑₛ−εₘ)]*sin[π(εᵣₑₛ−εₘ)]/{Nsin[π(εᵣₑₛ−εₘ)/N ]}. (37)

Removing the known pilot tone phases φₖₘ we find that each pilot tone has a phase offset

γₖₘ=π[1+2(mNₛ+N_{g})/N−1/N](εᵣₑₛ−εₘ) (38)

which is independent of sub-carrier number k. Note that without any further correction after the initial correction made during the synchronization process, the phase offset of the data sub-carriers as well as the pilot tones will accumulate with increasing symbol number m during the packet transmission. The phases of the four pilot tones are averaged for noise reduction according to

γₘ=(¼)Σγₖₘ (39)

and the remaining error in frequency offset is estimated from

errorₘ=(68 ᵣₑₛ−εₘ)=γₘ/π(1+2mNₛ/N−1/N). (40)

We use this error and our previous estimate to generate a new estimate for the m+1^{st} symbol

ε_{m+1=ε}ₘ+α*errorₘ (41)

which converges exponentially with increasing m to εᵣₑₛ for α<1. An ideal value for α has been determined to be 0.707.

The frequencies of the sampling clocks at the transmitter and receiver may not be exactly the same. Let

Δt′=(1+η)Δt (42)

where fₛ=1/Δt is the sampling clock frequency of the transmitter and fₛ′=1/Δt′ is the sampling clock frequency at the receiver. This error in the sampling clocks creates a cumulative timing error in the pilot tones {k=−21,−7,7,21} so that during the processing interval of data symbol number m

pₖₘ(n)=exp(jφₖₘ)*exp[j2πk{n(1+η)+η(mNₛ+N_{g})}/N],n=0,1, . . . N−1. (43)

The FFT coefficients of the pilot tones for OFDM data symbol m are

Pₖₘ=exp[jφₖₘ)]*exp[jπkη(1+2(mNₛ+N_{g})/N−1/N)]*sin(πkη/[N sin(πkη/N)]. (44)

Removing the known pilot tone phases φₖₘ we find that each pilot tone has a phase offset

βₖₘ=πkη[1+2(mNₛ+N_{g})/N−1/N] (45)

that is linearly dependent on sub-carrier number k and accumulates with increasing OFDM data symbol number m.

That is,

βₖₘ=μₘ*k (46)

where

μₘ=πη[1+2(mNₛ+N_{g})/N−1/N]. (47)

Consequently, the pilot tones and therefore the data sub-carrier tones are subjected to a total phase shift

Θₖₘ=γₘ+μ_{m*}k (48)

during OFDM data symbol number m. The pilot tone phases are subject to noise in addition to these systematic phase shift effects due to residual frequency offset error and sampling clock frequency error. Therefore a least squares estimate is obtained for γm and μm using the algorithms

γₘ=(1/4)ΣΘₖₘ (49)

and

μₘ=[Σ(Θₖₘ−γₘ)*k]/[Σk²]. (50)

The constant phase offset γₘ from (49) is used to correct the frequency offset for the subsequent symbol in accordance with (40) and (41). The slope of the phase shifts μₘ from (50) is used to correct the symbol timing for the subsequent symbol. This can be done in one of two ways. In the preferred embodiment, the channel compensation for the m+1^{st} symbol is corrected from that used for the m^{th} symbol in accordance with the algorithm

H(k)ₘ₊₁=H(k)ₘexp(−jkσₘ₊₁),m=0,1, . . . ,M−1 (51)

where

σₘ₊₁=σₘ+κ*μₘ. (52)

Here H(k)₀=H(k) from (34), the initial channel estimate obtained from the long sync signals and σ₀=0. Because the slope estimate μₘ is quite noisy, it is found in practice that a small value of κ≈0.03 is optimum for correcting the sampling clock errors throughout the OFDM WLAN packets assuming sampling clock accuracy of 5 in 10⁴ (20 MHz ±10 KHz). Even the least expensive integrated clock circuits easily meet this requirement.

In an alternate embodiment, the sample timing error is monitored according to

Δnₘ=σₘ/(2π).tm (53)

The timing error is monitored and if |Δnₘ|>½ the first sample point number for the following OFDM data symbol processing interval is slipped forward or backward by one according to whether Δn is negative or positive.

An advantage of the present invention is that the tracking loop errors depend only on phase change information of the pilot sub-carriers and its operation is independent of any amplitude variations that may occur to the pilots. The loop gain is kept less than one to assure stability in all noise environments.

The invention disclosed herein has a number of other distinct advantages over other OFDM WLAN synchronization systems and tracking systems. For example, the algorithms and methods described herein constitute an integrated system for initial synchronization and channel compensation using a known preamble. Additionally, the algorithm provides for continuous tracking and correction throughout the duration of the packet using the prescribed pilot tones. The combination of tracking and correction assures that each symbol in the packet is accurately synchronized and compensated prior to data decoding thereby providing a high level quality of service regardless of the packet length.

The cross-correlator used in the initial iteration of the digital synchronization circuitry has a gain of 22.8 dB. This is the highest gain achievable using the prescribed preamble. This gain is 10.8 dB greater than standard systems using the short sync symbols for detection and coarse carrier frequency offset estimation and 4.8 dB greater than standard systems using the long sync symbols for fine carrier frequency offset estimation. The high correlator gain means increased accuracy of the carrier frequency offset and symbol timing initial synchronization. It also means packet acquisition at 10.8 dB lower input signal-to-noise ratios than alternative techniques.

The correlator technique disclosed herein and employed for acquisition and initial synchronization is effectively immune to channel impairments, such as multi-path, because both the direct and delayed inputs to the cross-correlator 401 pass through the same channel. This resistance to channel impairments, in combination with the high gain of the correlator, makes the digital synchronization circuitry disclosed herein robust and fully capable of operating accurately and supporting data transmission using the OFDM WLAN Physical layer specified in the 802.11 standard.

A further advantage of the present invention is that the digital synchronization circuitry has a range for carrier frequency offset correction three times greater than competing techniques. The acquisition range of this circuit is in fact only limited by the size of the FFT in the receiver and the IF bandwidth. The offset correction can be made as large as required by increasing the size of the FFT in the receiver and the IF bandwidth. There is no effective loss of accuracy associated with achieving an increased acquisition range.

An additional feature of the present invention is that the pilot tone tracking circuitry can adjust each OFDM symbol for residual frequency offset error. The pilot tone tracking circuitry also adjusts each symbol for differences in the transmitter and receiver sampling rates (nominally 20 MHz) and/or residual symbol timing error.

The digital acquisition, synchronization and tracking circuitry herein disclosed provides robust and accurate synchronization of the carrier frequencies, the symbol sample timing and the sampling frequency clocks of the OFDM WLAN transmitters and receivers. In addition, it provides channel compensation for each OFDM sub-carrier of each symbol facilitating the required coherent demodulation of the OFDM sub-carriers at the receivers.

What is claimed:

1. A method for synchronizing a receiver to a transmitter comprising the following steps:
receiving a digital signal from the receiver;
delaying the digital signal by a sample processing interval to produce a delayed signal; and
correlating the digital signal and delayed signal to create a correlator output.

2. The method of claim 1 further comprising the additional steps of:
determining a magnitude of the correlator output; and
comparing the magnitude of the correlator output to a preset threshold value wherein when the magnitude exceeds the preset threshold value an incoming packet is detected at the receiver.

3. The method of claim 1 further comprising the additional steps of:
determining a magnitude of the correlator output;
monitoring time samples during which the magnitude of the correlator output exceeds a preset threshold value;
determining a sample point at which the magnitude of the correlator output is maximum;
back-biasing by at least one time sample.

4. The method of claim 1 further comprising the additional steps of:
determining a phase shift of the correlator output corresponding to a maximum value of the correlator output wherein the phase shift is an estimate of the fractional portion of carrier frequency offset.

5. A method for synchronizing a receiver to a transmitter comprising the following steps:
receiving a digital signal from the receiver;
demodulating long sync symbols from the digital signal; and
correcting for a fractional portion of frequency offset.

6. The method of claim 5 wherein the step of demodulating the long sync symbols is performed using a fast Fourier transform (FFT) processor in the receiver.

7. The method of claim 5 comprising the additional step of combining modulation values from two long sync symbols.

8. The method of claim 5 comprising the additional step of extracting vectors of modulation values of data sub-carriers with progressive trial integer offsets.

9. The method of claim 8 comprising the additional step of dividing each vector by long sync symbol modulation values to obtain channel transfer functions.

10. The method of claim 9 comprising the additional step of estimating odd frequency values for each of the channel transfer functions.

11. The method of claim 10 wherein the step of estimating odd frequency values is performed using an interpolation algorithm.

12. The method of claim 9 comprising the additional steps of:
correlating the interpolated odd frequency values of the channel transfer function and the actual odd frequency values; and
selecting a correlation value to identify an integer frequency offset number.

13. The method of claim 9 comprising the additional steps of:
correlating the interpolated odd frequency values of the channel transfer function and the actual odd frequency values to create a correlation value;
computing a magnitude of the correlation value; and
selecting the largest magnitude of the correlation value to identify an integer frequency offset number.

14. The method of claim 13 comprising the additional steps of:
associating the largest magnitude of the correlation value with a channel transfer function;
using the channel transfer function to correct data symbols for amplitude and phase shifts.

15. A method for synchronizing a receiver to a transmitter comprising the following steps:
receiving a digital signal from the receiver;
delaying the digital signal by a sample processing interval to produce a delayed signal;
correlating the digital signal and delayed signal to create a correlator output;
determining a phase shift of the correlator output corresponding to a maximum value of the correlator output wherein the phase shift is an estimate of the fractional portion of carrier frequency offset;
extracting long sync symbols from the digital signal;
correcting for a fractional portion of frequency offset;
extracting vectors of modulation values of data sub-carriers with progressive trial integer offsets;
dividing each vector by long sync symbol modulation values to obtain channel transfer functions;
estimating odd frequency values for each of the channel transfer functions;
correlating the interpolated odd frequency values of the channel transfer function and the actual odd frequency values; and
selecting a correlation value to identify an integer frequency offset number.

16. A method for deriving frequency offset correction and sample timing information for symbol number m+1 based on pilot tone information contained in symbol m of a sequence of N data symbols comprising the following steps:
extracting Fourier coefficients of the m^{th} symbol by way of a fast Fourier transform of the receiver;
dividing the Fourier coefficients by a channel response function to correct for amplitude variations and phase shifts during transmission and for phase shifts;
extracting phase shift offsets of pilot tones relative to known phase shifts for the m^{th} symbol;
approximating a straight line of the phase shifts versus frequency;
computing a frequency offset error based on the values of the phase shifts;
combining the frequency offset error with frequency offsets computed for the m^{th} symbol, creating the value of frequency offset to be used for the m+1 symbol; and
combining the slope of the straight line with the phase slope used in the channel response of the m^{th} symbol to create the phase slope of a channel response for the m+1^{st} symbol.

17. The method of claim 16 wherein the step of approximating a straight line of the phase shifts versus frequency is done using a least squares fit approximation.

18. A system for synchronizing digital signal at a receiver from a transmitter comprising:
means for delaying the digital signal by a sample processing interval to produce a delayed signal; and
a correlator for correlating the digital signal and delayed signal to create a correlator output.

19. The system of claim 18 further comprising:
an integrator for determining a magnitude of the correlator output; and
a comparator means for comparing the magnitude of the correlator output to a preset threshold value wherein when the magnitude exceeds the preset threshold value an incoming packet is detected at the receiver.

20. The system of claim 18 further comprising:
an integrator for determining a magnitude of the correlator output;
a means for monitoring samples during which the magnitude of the correlator output exceeds a preset threshold value;
a magnitude detector for determining a sample point at which the magnitude of the correlator output is maximum;
a delay means for back-biasing the received signal by at least one time sample.

21. The system of claim 18 further comprising:
a phase shift detector means for determining the phase shift of the correlator output corresponding to a maximum value of the correlator output wherein the phase shift is an estimate of the fractional portion of carrier frequency offset.
